(19) United States
(12) Patent Application Publication
(10) Pub. No.: US 2026/0155573 A1
(43) Pub. Date: Jun. 4, 2026

(54) ELECTRONIC DEVICE

(71) Applicant: Advanced Semiconductor Engineering, Inc., Kaohsiung (TW)

(72) Inventors: Po-I WU, Kaohsiung (TW); Hung-Chun KUO, Kaohsiung (TW); Ming-Fong JHONG, Kaohsiung (TW)

(73) Assignee: Advanced Semiconductor Engineering, Inc., Kaohsiung (TW)

(21) Appl. No.: 18/967,489

(22) Filed: Dec. 3, 2024

(51) Int. Cl. H01Q 9/06; H01Q 1/52; H01Q 21/06

(52) U.S. Cl. CPC H01Q 9/065; H01Q 1/526; H01Q 21/06

(57) ABSTRACT

An electronic device is disclosed. An electronic device includes a first pattern having a first corner and a second corner and a feeding element configured to electrically couple to the first pattern. The feeding element is closer to the first corner than to the second corner. The first pattern has a first tab adjacent to the first corner.

### BACKGROUND

### 1. Field of the Disclosure

The present disclosure generally relates to an electronic device.

### 2. Description of the Related Art

With the increasing demand for wearable technology, the development of compact and efficient antenna designs is essential. Magneto-electric (ME) dipole antennas offer superior bandwidth and gain characteristics compared to patch antennas, making them suitable for gigahertz (GHz) communications systems. However, incorporating a central patch between the dipoles to regulate impedance matching may increase the X-Y dimensions of the product.

### SUMMARY

In some arrangements, an electronic device includes a first pattern having a first corner and a second corner and a feeding element configured to electrically couple to the first pattern. The feeding element is closer to the first corner than to the second corner. The first pattern has a first tab adjacent to the first corner.

In some arrangements, an electronic device includes a first pattern and a second pattern having a plurality of tabs of a consistent width and extending toward the first pattern.

In some arrangements, an electronic device includes a first magneto-electric (ME) dipole antenna and a second ME dipole antenna adjacent to the first ME dipole antenna. The second ME dipole antenna has a first pattern and a second pattern. The first pattern has a first tab and a second tab configured to guide a consistent directional current in the second ME dipole antenna.

### BRIEF DESCRIPTION OF THE DRAWINGS

Aspects of some arrangements of the present disclosure are best understood from the following detailed description when read with the accompanying figures. It is noted that various structures may not be drawn to scale, and dimensions of the various structures may be arbitrarily increased or reduced for clarity of discussion.

FIG. 1A is a top view of an electronic device, in accordance with an arrangement of the present disclosure.

FIG. 1B is a cross-section of an electronic device, in accordance with an arrangement of the present disclosure.

FIG. 1C is a top view of an electronic device, in accordance with an arrangement of the present disclosure.

FIG. 2 is a perspective view of an electronic device, in accordance with an arrangement of the present disclosure.

FIG. 3 is a simulated graph of return loss versus frequency of an electronic device, in accordance with an arrangement of the present disclosure.

FIG. 4A is a top view of an electronic device, in accordance with an arrangement of the present disclosure.

FIG. 4B is a top view of an electronic device, in accordance with an arrangement of the present disclosure.

FIG. 4C is a top view of an electronic device, in accordance with an arrangement of the present disclosure.

FIG. 4D is a simulated graph of return loss versus frequency of an electronic device, in accordance with an arrangement of the present disclosure.

FIG. 5 shows simulated current distribution of an electronic device, in accordance with an arrangement of the present disclosure.

FIG. 6 is a top view of an electronic device, in accordance with an arrangement of the present disclosure.

FIG. 7 is a simulated graph of sidelobe level versus angle of an electronic device, in accordance with an arrangement of the present disclosure.

FIG. 8 is a top view of an electronic device, in accordance with a comparative embodiment of the present disclosure.

### DETAILED DESCRIPTION

Common reference numerals are used throughout the drawings and the detailed description to indicate the same or similar components. Arrangements of the present disclosure will be readily understood from the following detailed description taken in conjunction with the accompanying drawings.

The following disclosure provides many different arrangements, or examples, for implementing different features of the provided subject matter. Specific examples of components and arrangements are described below to explain certain aspects of the present disclosure. These are, of course, merely examples and are not intended to be limiting. For example, the formation of a first feature over or on a second feature in the description that follows may include arrangements in which the first and second features are formed or disposed in direct contact, and may also include arrangements in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various arrangements and/or configurations discussed.

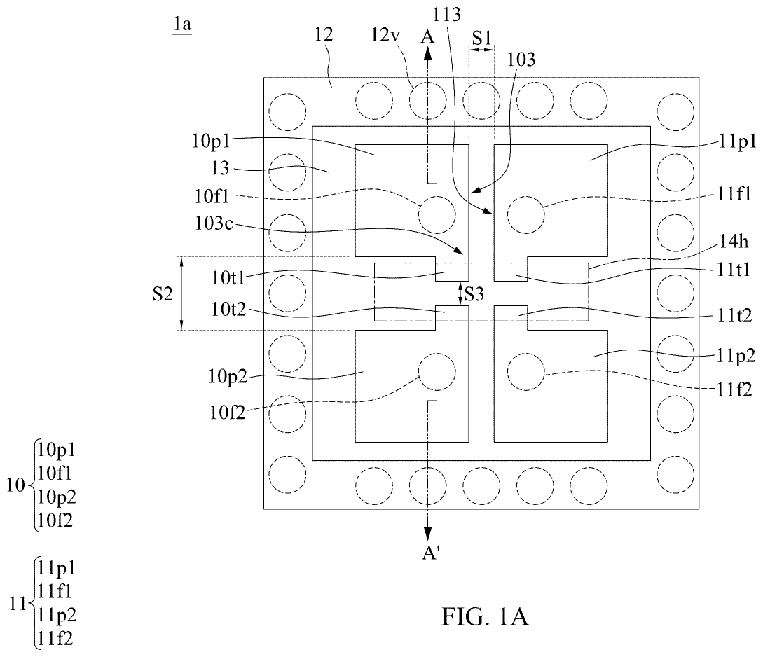

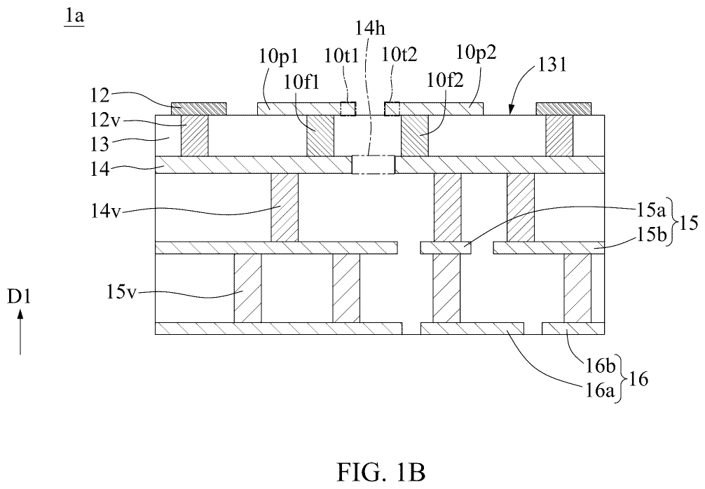

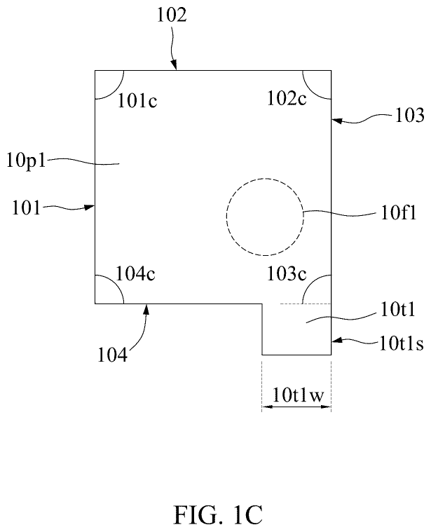

FIG. 1A is a top view of an electronic device 1a, in accordance with an arrangement of the present disclosure. FIG. 1B illustrates a cross-sectional view of the electronic device 1a along the line AA′ in FIG. 1A in accordance with some arrangements of the present disclosure. FIG. 1C illustrates a top view of a portion of the electronic device 1a, in accordance with an arrangement of the present disclosure.

In some arrangements, the electronic device 1a may be or include, for example, an antenna device or an antenna package. In some arrangements, the electronic device 1a may be or include, for example, a wireless device, such as user equipment (UE), a mobile station, a mobile device, an apparatus communicating with the Internet of Things (IoT), etc. In some arrangements, the electronic device 1a may be or include a portable device.

The electronic device 1a may include patterns 10p1, 10p2, 11p1, and 11p2, feeding elements 10f1, 10f2, 11f1, and 11f2, conductive layers 12, 14, 15, 16, conductive vias 12v, 14v, 15v, and a dielectric layer 13.

The patterns 10p1, 10p2, 11p1, and 11p2 may also be referred to as conductive elements, antenna elements, antenna patches, radiation elements, or radiation patches. The patterns 10p1, 10p2, 11p1, and 11p2 may be configured to radiate and/or receive electromagnetic (EM) waves/signals, such as radio waves, microwaves, infrared waves, X-rays, gamma rays, etc. The patterns 10p1, 10p2, 11p1, and 11p2 may be configured to operate at any desirable frequency (frequency band and/or bandwidth) to support fifth generation (5G) communications, beyond-5G communications, and/or 6G communications. For example, the patterns 10p1, 10p2, 11p1, and 11p2 may be configured to operate at microwave frequency bands, Sub-6 GHz frequency bands, 5 GHz frequency bands, terahertz (THz) frequency bands, etc.

The patterns 10p1, 10p2, 11p1, and 11p2 may be electrically coupled or connected to a respective feeding element. The feeding element may be configured to electrically couple or connect to a respective pattern. The patterns 10p1, 10p2, 11p1, and 11p2 may be capable of being excited by the feeding element.

For example, the pattern 10p1 may be electrically coupled or connected to the feeding element 10f1. The feeding element 10f1 may perpendicularly intersect with the pattern 10p1, with the midpoint of the intersection being the feed point. As used herein, the term “couple” is used to describe two electric circuits brought into sufficient proximity to permit mutual influence, inductive coupling, energy coupling, etc. As used herein, the term “connect” is used to describe two electric circuits being directly in contact with each other or conductively connected through an interconnect.

Similarly, the pattern 10p2 may be electrically coupled or connected to the feeding element 10f2. The pattern 11p1 may be electrically coupled or connected to the feeding element 11f1. The pattern 11p2 may be electrically coupled or connected to the feeding element 11f2.

The patterns 10p1, 10p2, 11p1, and 11p2 may include or be arranged in a 2×2 array. The patterns 10p1, 10p2, 11p1, and 11p2 may be substantially symmetrically arranged around a center of the dielectric layer 13 from a top view. The feeding elements 10f1, 10f2, 11f1, and 11f2 may be substantially symmetrically arranged around a center of the dielectric layer 13 from a top view.

The feeding elements 10f1, 10f2, 11f1, and 11f2 may be disposed close to one another. For example, a corner 103c of the pattern 10p1 may be closer to the patterns 10p2, 11p1, and 11p2 than one or more of the other corners of the pattern 10p1.

The feeding element 10f1 may be closer to the corner 103c than to the other corners of the pattern 10p1. For example, as shown in the enlarged view in FIG. 1C, the feeding element 10f1 may be closer to the corner 103c than to the corner 101c, the corner 102c, and/or the corner 104c. The feeding element 10f1 may be disposed adjacent to the corner 103c. The feeding element 10f1 may be disposed at the corner 103c.

The feeding element 10f1 may be closer to the patterns 10p2, 11p1, and 11p2 than one or more of the other corners of the pattern 10p1. When the feeding elements 10f1, 10f2, 11f1, and 11f2 are close together, it helps to minimize impedance mismatches and reduce losses in the transmission of energy.

The patterns 10p1 and 10p2, and the feeding elements 10f1 and 10f2 may be a part of an antenna 10. The patterns 10p1 and 10p2, and the feeding elements 10f1 and 10f2 may be collectively configured to form or constitute the antenna 10. The antenna 10 may include a magneto-electric (ME) dipole antenna. For example, the patterns 10p1 and 10p2 may be the electric dipoles of the antenna 10. The feeding elements 10f1 and 10f2 may be the magnetic dipoles of the antenna 10. The electric dipoles and magnetic dipoles of an ME dipole antenna work together to radiate EM waves and facilitate communication. This configuration makes an ME dipole antenna suitable for a wide range of applications, including wireless communication, radar, and sensing systems.

Similarly, the patterns 11p1 and 11p2 and the feeding elements 11f1 and 11f2 may be a part of an antenna 11, such as an ME dipole antenna.

The pattern 10p1 may have a tab 10t1. For example, as shown in the enlarged view in FIG. 1C, the pattern 10p1 may include a larger rectangular shape with a smaller rectangular shape connected to it. The larger and smaller rectangular shapes can be connected seamlessly, forming a monolithic and one-piece design. For example, the larger rectangular shape and the smaller rectangular shape may be contiguous. The larger rectangular shape and the smaller rectangular shape may be monolithic. The larger rectangular shape and the smaller rectangular shape may be formed in one-piece. The larger rectangular shape and the smaller rectangular shape may be seamless.

The larger rectangular shape of the pattern 10p1 may have four sides 101, 102, 103, and 104. The sides of the pattern 10p1 may be substantially perpendicular to an adjacent one. For example, the sides 101 and 102 may form, constitute, or define the corner 101c. For example, the sides 102 and 103 may form, constitute, or define the corner 102c. For example, the sides 103 and 104 may form, constitute, or define the corner 103c. For example, the sides 104 and 101 may form, constitute, or define the corner 104c.

The corner 103c may include a substantially vertical corner. The tab 10t1 may include the smaller rectangular shape. The tab 10t1 may protrude from the side 104. The tab 10t1 may be or include a protruding portion of the pattern 10p1. The side 104 may be recessed with respect to the tab 10t1. The tab 10t1 may extend from the side 104 of the pattern 10p1 toward the pattern 10p2 as shown in FIG. 1A.

The tab 10t1 may have a dimension (such as a width) 10t1w of about 30 micrometers (μm) to 90 μm, about 40 μm to 80 μm, or about 60 μm.

The tab 10t1 may be disposed adjacent to or at the corner 103c. The tab 10t1 may have a side 10t1s substantially aligned, coplanar, or contiguous with the side 103. The side 10t1s may be substantially flat or even.

The side 103 and the side 10t1s may together form or constitute the longest side of the pattern 10p1. For example, consider the pattern 10p1, which has a total of six sides when viewed from the top. The side 103 and the side 10t1s together form the side with the largest dimension. The longest side of the pattern 10p1 may be substantially flat or even. The longest side of the pattern 10p1 may face the pattern 11p1 as shown in FIG. 1A.

The antenna 10 may have two tabs. For example, the pattern 10p1 may have the tab 10t1 extending toward the pattern 10p2 and the pattern 10p2 may have a tab 10t2 extending toward the pattern 10p1. The tabs 10t1 and 10t2 of the antenna 10 may extend toward each other. The tabs 10t1 and 10t2 of the antenna 10 may extend opposite each other. The tabs 10t1 and 10t2 of the antenna 10 may be spaced apart from each other. The tabs 10t1 and 10t2 of the antenna 10 may not be in direct contact with each other. The tabs 10t1 and 10t2 of the antenna 10 may not be in physical contact with each other.

Similarly, the antenna 11 may have two tabs. For example, the pattern 11p1 may have the tab 11t1 extending toward the pattern 11p2 and the pattern 11p2 may have a tab 11t2 extending toward the pattern 11p1. The tabs 11t1 and 11t2 of the antenna 11 may extend towards each other. The tabs 11t1 and 11t2 of the antenna 11 may extend opposite each other. The tabs 11t1 and 11t2 of the antenna 11 may be spaced apart from each other. The tabs 11t1 and 11t2 of the antenna 11 may not be in direct contact with each other. The tabs 11t1 and 11t2 of the antenna 11 may not be in physical contact with each other.

In some arrangements, there may be no tabs on the side of the antenna 10 facing the antenna 11. For example, the side 103 of the antenna 10 facing the antenna 11 may be substantially flat or even. The side 113 of the antenna 11 facing the antenna 10 may be substantially flat or even.

In some arrangements, there may be two different distances S2 and S3 between the patterns 10p1 and 10p2 of the antenna 10. The distance S2 may be determined by measuring the space between the opposing surfaces of the patterns 10p1 and 10p2. The distance S3 may be determined by measuring the space between the opposing surfaces of the tabs 10t1 and 10t2. The distance S2 may be the longest distance between the opposing surfaces of the patterns 10p1 and 10p2. The distance S3 may be the shortest distance between the opposing surfaces of the tabs 10t1 and 10t2. In some arrangements, the distance S2 may range from approximately 100 μm to 120 μm. In some arrangements, the distance S3 may be less than about 120 μm. In some arrangements, the distance S3 may be less than about 100 μm.

In some arrangements, adjusting the distance S2 can effectively reduce parasitic capacitance. However, it is crucial to consider that this adjustment may lead to a larger X-Y dimension for the product. By implementing two distinct distances, S2 and S3, between the patterns 10p1 and 10p2 of the antenna 10, it is possible to minimize parasitic capacitance without sacrificing miniaturization.

The antenna 10 may be spaced apart from the antenna 11 by a distance S1. The distance S1 may be determined by measuring the space between the opposing surfaces of patterns 10p1 and 11p1. The distance S1 may be the shortest distance between the pattern 10p1 and the pattern 11p1. In some arrangements, the distance S2 may range from approximately 60 μm to 120 μm. In some arrangements, the distance S1 may be less than the distance S2. In some arrangements, the distance S2 may be greater than the distance S1. In some arrangements, the distance S1 may be substantially equal to the distance S2.

In some arrangements, the distance S3 may be less than the distance S2. In some arrangements, the distance S3 may be less than the distance S1. In some arrangements, the distance S3 may be substantially equal to the distance S1.

The tabs 10t1, 10t2, 11t1, and 11t2 may be disposed close to the respective feeding elements 10f1, 10f 2, 11f1, and 11f 2. For example, the tab 10t1 may be disposed adjacent to the corner 103c where the feeding element 10f1 is disposed. For example, the feeding element 10f1 may be disposed closer to the corner 103c than to one or more of the other corners 101c, 102c, and 104c of the pattern 10p1, and the tab 10t1 may be disposed adjacent to the corner 103c. For example, the feeding element 10f1 and the tab 10t1 may both be disposed closer to the corner 103c than to one or more of the other corners 101c, 102c, and 104c of the pattern 10p1.

The tabs 10t1, 10t2, 11t1, and 11t2 may be disposed close to one another. For example, the corner 103c of the pattern 10p1 may be closer to the patterns 10p2, 11p1, and 11p2 than the other corners 101c, 102c, and 104c of the pattern 10p1. The tab 10t1 may be disposed adjacent to the corner 103c. The tab 10t1 may be disposed at the corner 103c. By positioning the tabs 10t1, 10t2, 11t1, and 11t2 in close proximity to their corresponding feeding elements 10f1, 10f2, 11f1, and 11f2, the energy transmission can be decreased and the overall antenna performance can be enhanced.

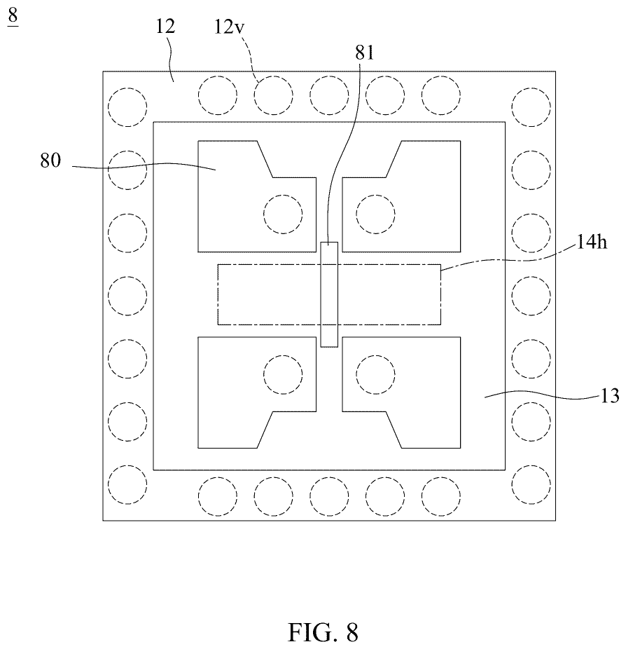

FIG. 8 is a top view of an electronic device 8, in accordance with a comparative embodiment of the present disclosure. In the comparative embodiment, a central patch 81 may be added among the patterns 80 to regulate impedance matching. However, such design modification may result in an increase in the overall X-Y dimensions of the product.

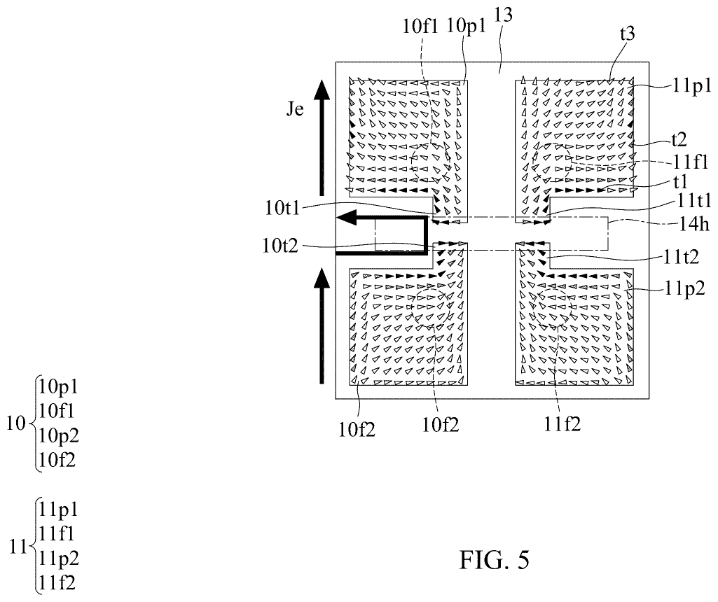

According to some arrangements of the present disclosure, the use of a tab design in antenna arrays improves impedance matching and allows for a smaller antenna array size compared to traditional ME dipole antenna arrays, meeting the demand for miniaturization. With the tabs 10t1, 10t2, 11t1, and 11t2, the radiation pattern for the antennas 10 and 11 of the electronic device 1a may be balanced and symmetrical. The simulated current distribution image in FIG. 5 indicates that the current Jₑ of the tab design is more consistent in direction, resulting in a better excitation effect of the antenna.

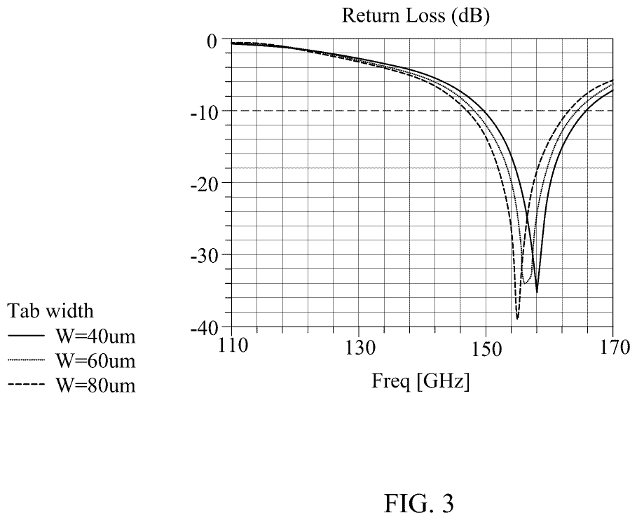

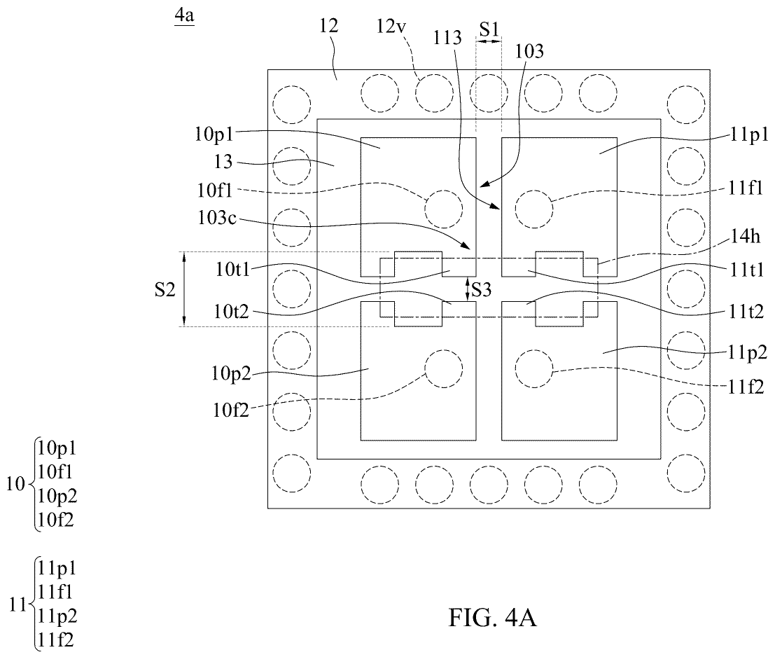

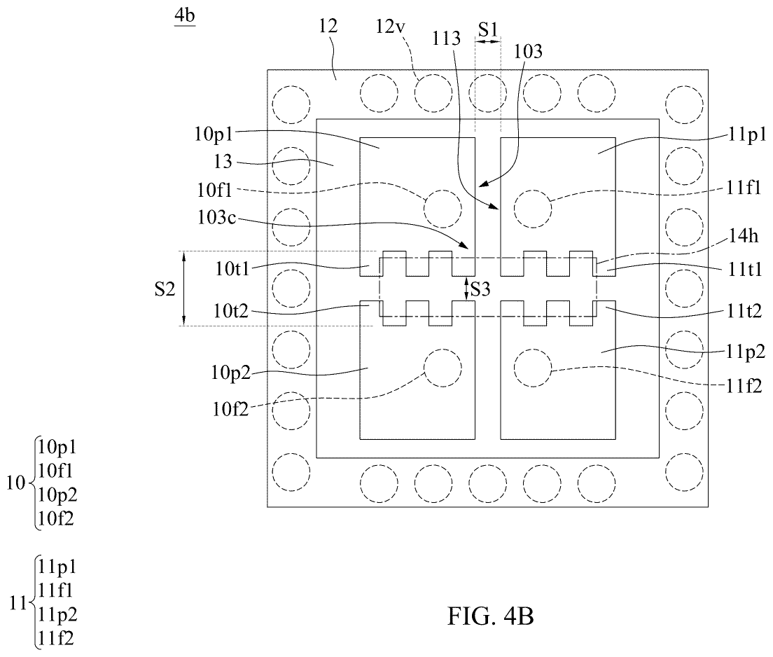

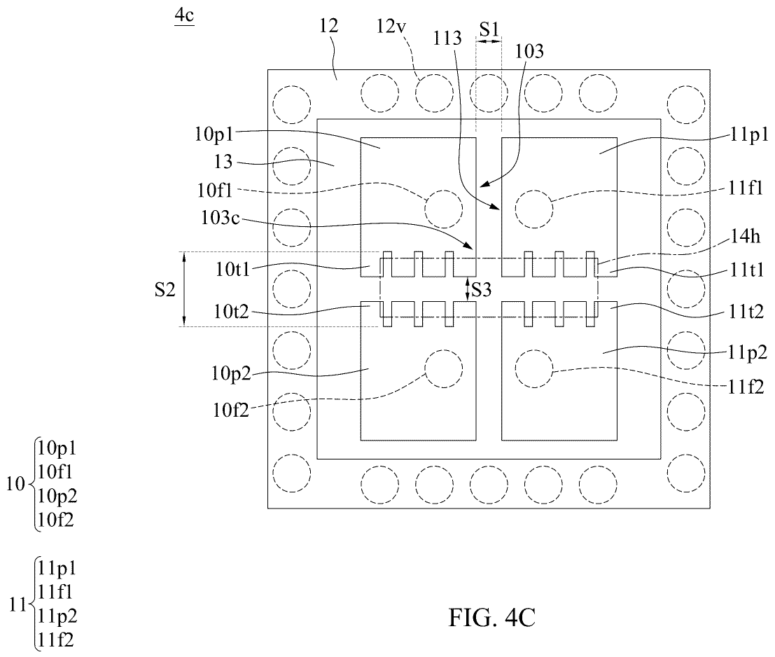

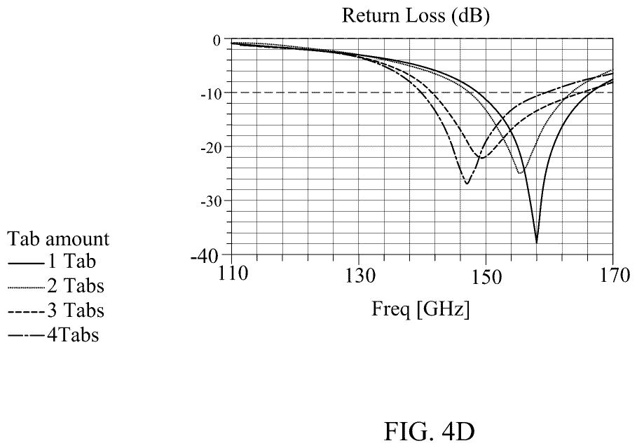

Furthermore, the tab design offers flexibility to adjust impedance according to different frequency and bandwidth requirements, enhancing design flexibility without increasing the overall area. For example, the simulated graph in FIG. 3 suggests that the tab width may serve as a potential variable for adjusting the operating frequency. Similarly, the simulated graph in FIG. 4D suggests that the tab quantity could potentially be a variable for modifying the operating frequency.

In some arrangements, the conductive layer 12 may surround the antennas 10 and 11. The conductive layer 12 may be electrically coupled or connected to the conductive vias 12v. In some embodiments, the conductive layer 12 may be configured to provide electromagnetic interference (EMI) shielding protection for the antennas 10 and 11 of the electronic device 1a. In some embodiments, the conductive layer 12 may be configured to serve as a shield against EMI. For example, the conductive layer 12 may be configured to provide an EMI shielding to prevent the antennas 10 and 11 of the electronic device 1a from being interfered with by other electronic components, and vice versa.

In some arrangements, as shown in FIG. 1B, the conductive layer 12 and the patterns 10p1 and 10p2 may be disposed over the dielectric layer 13. The conductive layer 12 and the patterns 10p1 and 10p2 may be disposed over a top surface 131 of the dielectric layer 13. The conductive layer 12 and the patterns 10p1 and 10p2 may be disposed at substantially the same elevation. For example, the conductive layer 12 and the patterns 10p1 and 10p2 may be disposed at substantially the same elevation with respect to the conductive layer 14.

In some arrangements, the conductive layer 12 may be partially or entirely covered or surrounded by the dielectric layer 13. In some arrangements, the patterns 10p1 and 10p2 may be partially or entirely covered or surrounded by the dielectric layer 13.

The conductive vias 12v and the feeding elements 10f1 and 10f2 may penetrate a portion of the dielectric layer 13. The conductive vias 12v and the feeding elements 10f1 and 10f2 may be disposed at the same elevation in the dielectric layer 13. The conductive vias 12v and the feeding elements 10f1 and 10f2 may be disposed at substantially the same elevation with respect to the conductive layer 14.

The conductive vias 12v and the feeding elements 10f1 and 10f2 may each be electrically coupled or connected with the conductive layer 14.

The conductive layer 14 may include or define a slot 14h. The slot 14h may be configured to be electrically coupled or connected to the tabs 10t1, 10t2, 11t1, and 11t2. EM waves radiated through the slot 14h may be electrically coupled to the tabs 10t1, 10t2, 11t1, and 11t2.

The slot 14h may be or include an opening filled with the dielectric layer 13. As shown in FIG. 1B, the slot 14h may be located at an elevation different from that of the tabs 10t1, 10t2, 11t1, and 11t2 along a direction D1. The direction D1 may be a vertical direction, and the conductive layers 16, 15, 14, and 12 may be stacked along the direction D1. The slot 14h may be separated from the tabs 10t1, 10t2, 11t1, and 11t2 by the dielectric layer 13 along the direction D1. The slot 14h may be spaced apart from the tabs 10t1, 10t2, 11t1, and 11t2 along the direction D1. The slot 14h may be disposed on an opposing side of the dielectric layer 13 with respect to the tabs 10t1, 10t2, 11t1, and 11t2.

A contour of the slot 14h is illustrated in FIG. 1A. A projection of the slot 14h on the top surface 131 of the dielectric layer 13 may be partially between the patterns 10p1 and 10p2, and partially between the patterns 11p1 and 11p2. The slot 14h may be symmetrically arranged around a center of the dielectric layer 13.

The tabs 10t1, 10t2, 11t1 and 11t2 may each be overlapped with the projection of the slot 14h. The tabs 10t1, 10t2, 11t1, and 11t2 may overhang the slot 14h. The tabs 10t1, 10t2, 11t1 and 11t2 may protrude beyond the slot 14h.

The conductive via 14v may be electrically coupled or connected between the conductive layers 14 and 15. The conductive layer 15 may include a coaxial connector 15a and a grounding element 15b.

The conductive via 15v may be electrically coupled or connected between the conductive layers 15 and 16. The conductive layer 16 may include a transmission line (such as a microstrip line) 16a and a grounding element 16b. In some arrangements, the transmission line 16a may be electrically coupled to an electronic component (not illustrated). The electronic component may include one or more of a radio frequency (RF) integrated circuit (IC), an analog-to-digital (A/D) converter, a digital-to-analog (D/A) converter, a filter, a low noise amplifier (LNA), a power amplifier, a multiplexer, a demultiplexer, a modulator, a demodulator, and so on.

In some arrangements, the conductive layers 14 and 15 and the conductive vias 14v may constitute or form a waveguide. In some arrangements, the waveguide may include a substrate integrated waveguide (SIW) or another three-dimensional structure for transmitting, guiding, propagating and/or directing electromagnetic waves. For example, EM waves may be fed into the waveguide through the coaxial connector 15a, propagate in the interior defined by the conductive vias 14v, and then be radiated through the slot 14h.

According to some arrangements of the present disclosure, by overlapping the tabs 10t1, 10t2, 11t1, and 11t2 with the slot 14h, the EM waves radiated through the slot 14h may improve the coupling efficiency between the waveguide and the antenna.

In some arrangements, the patterns 10p1, 10p2, 11p1, and 11p2, the feeding elements 10f1, 10f2, 11f1, and 11f2, the tabs 10t1, 10t2, 11t1, and 11t2, the conductive layers 12, 14, 15, and 16, and the conductive vias 12v, 14v, and 15v may each include a conductive material such as metal or metal alloy. Examples of the conductive material may include, but are not limited to, gold (Au), silver (Ag), copper (Cu), platinum (Pt), palladium (Pd), other metals or alloys, or a combination thereof.

In some arrangements, the conductive layers 14, 15, and 16 may be surrounded or covered by the same single dielectric layer, i.e., the dielectric layer 13. In some arrangements, the conductive layers 14, 15, and 16 may be surrounded or covered by a plurality of different dielectric layers.

In some arrangements, the dielectric layer 13 may include an epoxy resin having fillers, a molding compound (e.g., an epoxy molding compound or another molding compound), a polyimide, a phenolic compound or material, a material with a silicone dispersed therein, or a combination thereof. In some arrangements, the dielectric layer 13 may include pre-impregnated composite fibers (e.g., pre-preg), ceramic-filled polytetrafluoroethylene (PTFE) composites, Borophosphosilicate Glass (BPSG), silicon oxide, silicon nitride, silicon oxynitride, Undoped Silicate Glass (USG), any combination thereof, or the like. Examples of a pre-preg may include, but are not limited to, a multilayer structure formed by stacking or laminating a number of pre-impregnated materials/sheets.

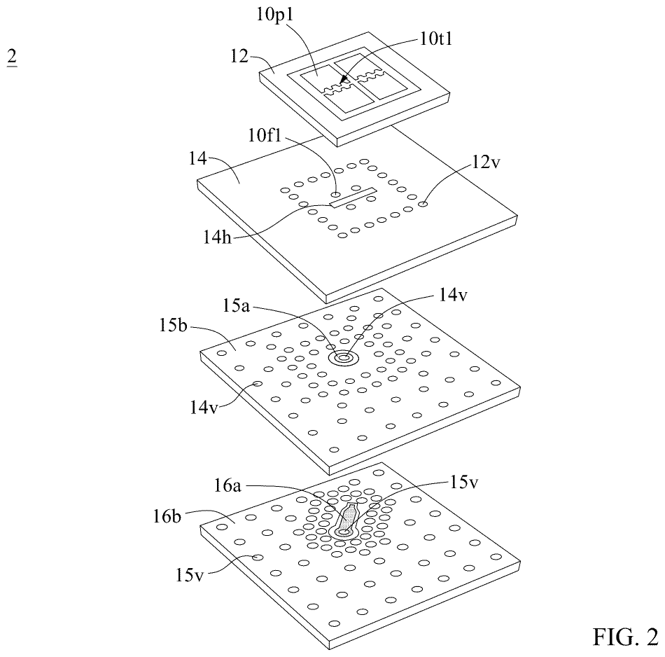

FIG. 2 illustrates a perspective view of an electronic device 2 in accordance with some arrangements of the present disclosure. In some arrangements, the same or similar elements in FIG. 2 and FIG. 1B are annotated with the same symbols, and the same or similar descriptions are not repeated hereinafter for conciseness.

The electronic device 2 is similar to the electronic device 1a except that the patterns 10p1 of the electronic device 2 may each have four tabs 10t1. The shape, dimensions, and quantity of the tabs 10t1 may be chosen based on factors related to the EM waves, which may include resonant frequency, impedance, admittance (the reciprocal of impedance), phase, wavelength, etc.

FIG. 3 is a simulated graph of return loss versus frequency of the electronic device 2, in accordance with an arrangement of the present disclosure. The return loss of an antenna device indicates the portion of the input EM waves supplied to the antenna device that is reflected back to the input port. The design goal is typically to keep the return loss as low as possible (typically below-10 dB). As shown in FIG. 3, the tab width of about 40 μm may be more suitable for high frequency application. The tab width of about 80 μm may have the lowest return loss and a better impedance matching.

FIG. 4A, FIG. 4B, and FIG. 4C illustrate top views of electronic devices 4a, 4b, and 4c in accordance with some arrangements of the present disclosure. Although each pattern has one tab in FIG. 1A, the quantity of the tabs is not limited thereto. For example, each pattern may have two tabs as shown in FIG. 4A, three tabs as shown in FIG. 4B, or four tabs as shown in FIG. 4C. In some arrangements, the tabs of a pattern may be substantially equally spaced. In some arrangements, the tabs of a pattern may have a consistent width.

In some arrangements, the tabs of a pattern may be located on the same side of the pattern. For example, the tabs of a pattern may be situated exclusively on one side of the pattern. For example, in FIG. 4C, the tabs 10t1 may only be present on the side of the pattern 10p1 that is facing the pattern 10p2. The remaining sides of pattern 10p1 may be devoid of tabs, appearing substantially flat or even. For example, a surface of the pattern 10p1 that is facing the pattern 10p2 may include a square wave boundary. The remaining surfaces of pattern 10p1 may include a substantially flat or even boundary.

In some arrangements, the tabs of each pattern may overhang the slot 14h. The tabs of each pattern may protrude beyond the slot 14h. The tabs of each pattern may be overlapped with the projection of the slot 14h.

FIG. 4D is a simulated graph of return loss versus frequency of the electronic devices with different tab quantities, in accordance with an arrangement of the present disclosure. As shown in FIG. 4D, the 1-tab design (as shown in FIG. 1A) may have the lowest return loss and a better impedance matching. The 1-tab design (as shown in FIG. 1A) may be more suitable for high frequency application. The 4-tab design (as shown in FIG. 4C) may be more stable in the D-band (i.e., a frequency band that ranges from 110 GHz to 170 GHz).

FIG. 5 shows current distribution of the electronic device 1a, in accordance with an arrangement of the present disclosure.

The all-black vector t1 represents a magnetic field between 30 and 46 A/m (ampere per meter), the striped vector t2 represents a magnetic field between 15 and 30 A/m, and the all-white vector t3 represents a magnetic field between 0 and 15 A/m.

To guide a consistent directional current flow in the antenna (e.g., the ME dipole antenna) of the electronic device 1a, the tabs 10t1 and 10t2 of the antenna 10 may protrude toward each other. It is shown that currents Jₑ on the pattern 10p1 and the pattern 10p2 of the antenna 10 flow in substantially the same direction. Similarly, the currents on the pattern 11p1 and the pattern 11p2 of the antenna 11 flow in substantially the same direction. The current intensity is greater in the upward and downward directions. The lateral interference between the antenna 10 and the antenna 11 is reduced. This results in a more efficient and effective radiation pattern for the antenna (e.g., the ME dipole antenna) of the electronic device 1a.

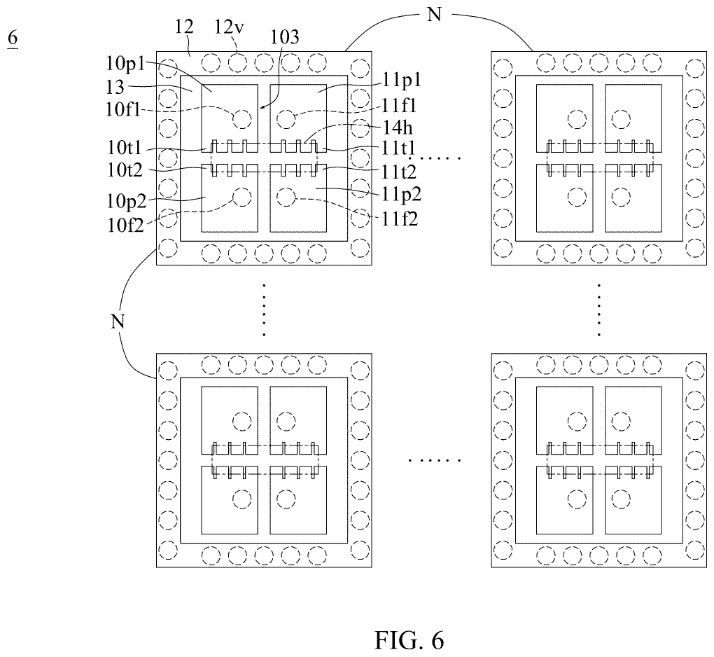

FIG. 6 illustrates a top view of an electronic device 6 in accordance with some arrangements of the present disclosure. The electronic device 6 includes the electronic device 4c (with a four-tab design) arranged in an N×N array. In some arrangements, the electronic device 6 may include the electronic device 4c (with a four-tab design) arranged in an 2×2 array, 4×4 array, 8×8 array, or more.

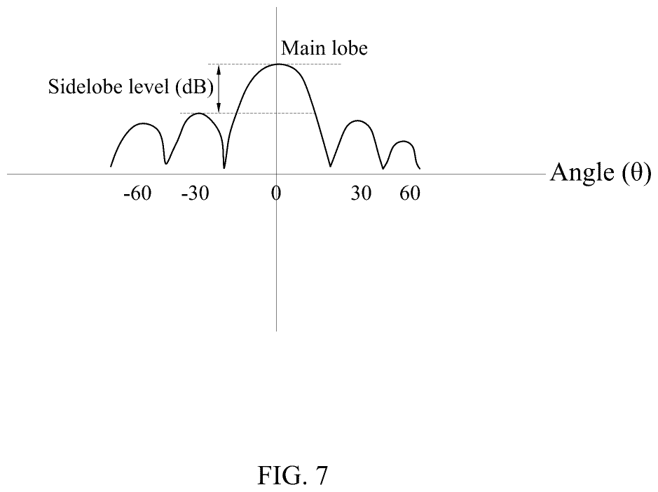

FIG. 7 is a simulated graph showing the relationship between sidelobe level and the angle of the electronic device 6, with N being 2, in accordance with an arrangement of the present disclosure.

According to some arrangements of the present disclosure, simulation data show that the peak gain per unit area (dBi/mm²) of the electronic device 4c (with a four-tab design) arranged in a 2×2 array is about 1.63 dBi/mm², which is about twice that of the comparative embodiment using the central patch. In addition, the sidelobe level (dB) of the electronic device 4c (with a four-tab design) arranged in a 2×2 array is about 15.7 dB, which is about twice that of the comparative embodiment using the central patch. Furthermore, the size of the electronic device 6 arranged in a 2×2 array is about 2.6×2.6 mm², which is smaller than the comparative embodiment using the central patch.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of arrangements of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific arrangements thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other arrangements of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a first pattern having a first corner and a second corner; and
a feeding element configured to electrically couple to the first pattern, wherein the feeding element is closer to the first corner than to the second corner, and
wherein the first pattern has a first tab adjacent to the first corner.

2. The electronic device of claim 1, wherein the first tab is closer to the first corner than to the second corner.

3. The electronic device of claim 1, wherein the first pattern has a larger rectangular shape and the first tab has a smaller rectangular shape connected to the larger rectangular shape.

4. The electronic device of claim 1, wherein the first tab has a side substantially coplanar with a side of the first pattern.

5. The electronic device of claim 4, wherein the side of the first tab is substantially flat.

6. The electronic device of claim 4, wherein the side of the first tab constitute a longest flat side of the first pattern from a top view.

7. The electronic device of claim 1, further comprising:
a second pattern, wherein the first tab extends toward the second pattern.

8. The electronic device of claim 7, wherein the second pattern has a second tab extending toward the first pattern.

9. The electronic device of claim 7, wherein the first pattern and the second pattern form a first magneto-electric (ME) dipole antenna.

10. The electronic device of claim 1, further comprising:
a conductive layer defining a slot, wherein a projection of the first tab overlaps a projection of the slot from a top view.

11. An electronic device, comprising:
a first pattern; and
a second pattern having a plurality of tabs of a consistent width and extending toward the first pattern.

12. The electronic device of claim 11, wherein the plurality of tabs are substantially equally spaced.

13. The electronic device of claim 11, wherein a distance between the first pattern and a third pattern is less than a distance between the first pattern and the second pattern.

14. The electronic device of claim 11, further comprising:
a first conductive layer defining a slot, wherein the plurality of tabs overhang the slot.

15. The electronic device of claim 14, further comprising:
a second conductive layer surrounding the first pattern and the second pattern and configured to provide an electromagnetic interference (EMI) shielding protection.

16. The electronic device of claim 15, wherein the second conductive layer, the first pattern, and the second pattern are disposed over a top surface of a dielectric layer.

17. The electronic device of claim 15, further comprising:
a conductive via connected between the first conductive layer and the second conductive layer.

18. The electronic device of claim 17, further comprising:
a feeding element connected between the first conductive layer and the first pattern.

19. An electronic device, comprising:
a first magneto-electric (ME) dipole antenna; and
a second ME dipole antenna adjacent to the first ME dipole antenna and having a first pattern and a second pattern;
wherein the first pattern has a first tab and a second tab configured to guide a consistent directional current in the second ME dipole antenna.

20. The electronic device of claim 19, wherein the first tab includes a first protruding portion extending toward the second pattern, and the second tab includes a second protruding portion extending toward the first pattern.
